(19) United States
(12) Patent Application Publication
(10) Pub. No.: US 2020/0234233 A1
(43) Pub. Date: Jul. 23, 2020

(54) SYSTEMS AND METHODS FOR CLASSIFYING GLOBAL EXPORTS

(71) Applicant: Thomson Reuters Global Resources Unlimited Company, Baar (CH)

(72) Inventors: Keith HAURIE, Fair Haven, NJ (US); Suzanne OFFERMAN, Brooklyn, NY (US); Andrew MOXON, Grand Rapids, MI (US)

(21) Appl. No.: 16/666,173

(22) Filed: Oct. 28, 2019

Related U.S. Application Data
(60) Provisional application No. 62/750,859, filed on Oct. 26, 2018.

(51) Int. Cl. G06Q 10/08; G06K 9/62; G06N 20/00

(52) U.S. Cl. CPC G06Q 10/0831; G06N 20/00; G06K 9/6267

(57) ABSTRACT

The present disclosure is directed towards systems and methods for classifying global imports and exports, which comprises receiving one or more product data items each associated with a product for global export or import and selecting one product data item from the one or more product data item associated with products for global export and import. The selected product data item are compared to a set of country export control lists using machine leaning. The disclosed systems and methods further comprise identifying one or more country export control number that are a potential match to the selected product data item based on said comparison, scoring each of the one or more country export control numbers and presenting each of the scored export control numbers on a graphical user interface for selection at an access device.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to this document: Copyright 2019 Thomson Reuters.

### TECHNICAL FIELD

This disclosure relates is directed towards systems and methods for classifying global imports and exports.

### BACKGROUND

Export compliance, i.e. determining export classification numbers, licensing requirements, and export restrictions in global trade, is a complex, time consuming task for trade professionals. Failure to comply with export regulations can delay shipments or subject the exporter to penalties, fines, or loss of export privileges. For multi-national companies, sharing information across geographically dispersed businesses and maintaining export documentation is sub-optimal. Multi-national companies rely on a hodgepodge of government websites, electronic spreadsheets, or internally developed software to manage export classification. In addition, institutions that finance exports need assurance that these transactions are not being used for illicit activities, such as money laundering. Accordingly, a tool that automates a company's ability to execute end-to-end export classification process is needed.

### SUMMARY

The present disclosure is directed towards systems and methods for classifying global imports and exports. The present invention simplifies the critical compliance task of manually classifying and determining licensing requirements for global exports by automating the classification process by allowing the user to assign the appropriate classification code and determine licensing requirements and export restrictions while maintaining an audit trail of documentation supporting their classification decisions. This capability will in turn reduce the time spent on classification and export licensing determination as well as minimize the risk of penalties and delaying exports due to improperly classified products or incomplete documentation. Details of various embodiments are discussed in greater detail below.

Additional features and advantages will be readily apparent from the following detailed description, the accompanying drawings and the claims.

### BRIEF DESCRIPTION OF THE DRAWINGS

FIG. 1 is a schematic depicting an exemplary computer-based system for classifying global imports and exports;

FIG. 2 is a flow diagram illustrating an exemplary computer-implemented method for classifying global imports and exports;

FIG. 3 is a screen diagram of an exemplary screen shot of graphical user interface used for classifying global imports and exports;

FIG. 4 is a screen diagram of an exemplary screen shot of graphical user interface used for classifying global imports and exports;

FIG. 5 is a screen diagram of an exemplary screen shot of graphical user interface used for classifying global imports and exports;

FIG. 6 is a screen diagram of an exemplary screen shot of graphical user interface used for classifying global imports and exports; and

FIG. 7 is a screen diagram of an exemplary screen shot of graphical user interface used for classifying global imports and exports.

Like reference symbols in the various drawings indicate like elements.

### DETAILED DESCRIPTION

In the following description, reference is made to the accompanying drawings that form a part hereof, and in which is shown by way of illustration specific embodiments in which the disclosure may be practiced. It is to be understood that other embodiments may be utilized, and structural changes may be made without departing from the scope of the present disclosure.

The present invention is directed to a software solution to help exporters around the globe to determine Export Control Classification Numbers (“ECN”) for physical products, technology and software being exported. Presently, normal software solutions only present to the user the complete classification list with keyword search tools and it is up to the user to search, read and find the code that is correct for a certain product, but the present invention will utilize artificial intelligence techniques to advance the classification process and increase the confidence of the user

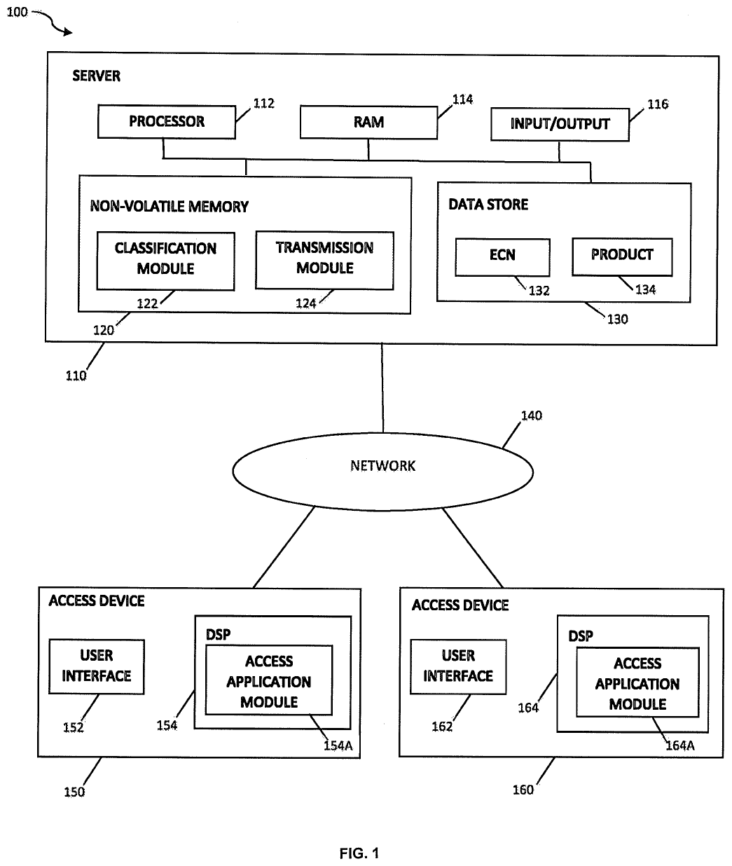

Turning now to FIG. 1, an example of a suitable computing system 100 within which embodiments of the disclosure may be implemented is presented. The computing system 100 is only one example and is not intended to suggest any limitation as to the scope of use or functionality of the disclosure. Neither should the computing system 100 be interpreted as having any dependency or requirement relating to any one or combination of illustrated components.

For example, the present disclosure is operational with numerous other general purpose or special purpose computing consumer electronics, network PCs, minicomputers, mainframe computers, laptop computers, as well as distributed computing environments that include any of the above systems or devices, and the like.

The disclosure may be described in the general context of computer-executable instructions, such as program modules, being executed by a computer. Generally, program modules include routines, programs, objects, components, data structures, loop code segments and constructs, and other computer instruction known to those skilled in the art that perform particular tasks or implement particular abstract data types. The disclosure can be practiced in distributed computing environments where tasks are performed by remote processing devices that are linked through a communications network. In a distributed computing environment, program modules are located in both local and remote computer storage media including memory storage devices. Tasks performed by the programs and modules are described below and with the aid of figures. Those skilled in the art may implement the description and figures as processor executable instructions, which may be written on any form of a computer readable media.

In one embodiment, with reference to FIG. 1, the system 100 includes a server 110 configured to include a processor 112, such as a central processing unit (“CPU”), random access memory (“RAM”) 114, one or more input-output devices 116, such as a display device (not shown) and keyboard (not shown), non-volatile memory 120 and data store 130, all of which are interconnected via a common bus and controlled by the processor 112.

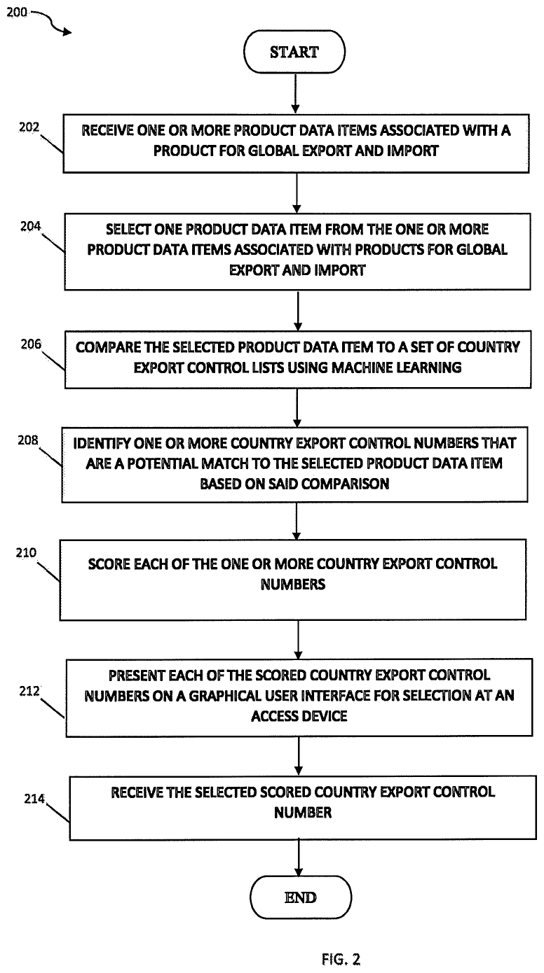

As shown in the FIG. 1 example, in one embodiment, the non-volatile memory 120 is configured to include a classification module 122 and a transmission module 124. The classification module 122 is configured to perform matching and scoring functionalities as described in connection with FIG. 2. The transmission module 124 is configured to transmit and present data files maintained in a data store 30 to one or more client access devices 150 and 160. Additional details of modules 122 and 124 are discussed in connection with FIGS. 2-9.

The data store 130 of the product server 110 is a repository that maintains and stores information utilized by the before-mentioned modules 122 and 124. In one embodiment, the data store 130 is a relational database. In another embodiment, the data store 130 is a directory server, such as a Lightweight Directory Access Protocol (“LDAP”). In yet another embodiment, the data store 130 is an area of non-volatile memory 120 of the product server device 110.

In one embodiment, as shown in the FIG. 1 example, the data store 130 includes a ECN database 132 and a product database 134. The ECN database 132 is configured to maintain one or more ECN classification lists. An ECN classification list maintains a listing of Export Control Classification Numbers (also referred to singularly as “ECCN” or “ECN”), which are five character alpha-numeric designations used on the Commerce Control List (CCL) to identify dual-use items for export control purposes. An ECCN categorizes items based on the nature of the product, i.e. type of commodity, software, or technology and its respective technical parameters. The classification list is maintained by different countries based on the Wassenaar Arrangement, an international regime in which member countries agree to implement export controls for “dual use” items. Dual use items could include items that have potential civilian uses, as well as weapon of mass destruction or conventional weapons related end uses. The product database 134 is operative to store one or more product data items associated with products for global export and import that are received by the system 100, as well as the selected ECNs that have been determined by the system 100.

Although the data store 130 shown in FIG. 1 is connected to the network 140, it will be appreciated by one skilled in the art that the data store 130 and/or any of the information shown therein, can be distributed across various servers and be accessible to the server 110 over the network 140, be coupled directly to the client server 110, or be configured in an area of non-volatile memory 120 of the server 110.

As shown in FIG. 1, in one embodiment, a network 140 is provided that can include various devices such as routers, server, and switching elements connected in an Intranet, Extranet or Internet configuration. In one embodiment, the network 140 uses wired communications to transfer information between the product server 110 and the client server 150. In another embodiment, the network 140 employs wireless communication protocols to transfer information between the access devices 150 and 160, the server device 110 and the data store 130. For example, the network 150 may be a Wide Area Network (WAN), such as the Internet, which employs one or more transmission protocols, e.g. TCP/IP. The network 150 may also be a cellular or mobile network employing digital cellular standards including but not limited to the 3GPP, 3GPP2 and AMPS family of standards such as Global System for Mobile Communications (GSM), General Packet Radio Service (GPRS), CDMAOne, CDMA2000, Evolution-Data Optimized (EV-DO), LTE Advanced, Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN). As another example, the network 150 may employ a combination of digital cellular standards and transmission protocols. In yet other embodiments, the network 140 may employ a combination of wired and wireless technologies to transfer information between the access devices 150 and 160, the server device 110 and the data store 130. In yet another embodiment, the network 140 employs a combination of wired and wireless technologies to transfer information between the access devices 150 and 160 and the server device 110. In another embodiment, the network 140 employs wireless communication protocols to transfer information between the access devices 150 and 160 and the server 110.

The access devices 150 and 160, according to one embodiment, are general purpose or special purpose computing devices comprising: a graphical user interface (“GUI”), GUI 152 and GUI 162, respectively; a digital signal processor (“DSP”), DSP 154 and DSP 164, respectively; each DSP having an access application module that allows a user to access the server 110, access application module 154A and access application module 164A, respectively; transient and persistent storage devices (not shown); an input/output subsystem (not shown); and a bus to provide a communications path between components comprising the general purpose or special purpose computer (not shown). According to one embodiment, access application module 154A and access application module 1654A use thin client applications (not shown) to access the server 110. According to another embodiment, access application module 154A and access application module 164A are web-based and use thin client applications (not shown), such as a web browser, which allows a user to access the server 110. Examples of web browsers are known in the art, and include well-known web browsers such as such as Microsoft® Internet Explorer®, Google Chrome™, Mozilla Firefox® and Apple® Safari®. Although system 100 is described generally herein as comprising two separate access devices, access devices 150 and 160, it should be appreciated that the present invention does not require at least two separate access devices, nor is it limited to solely two access devices. Indeed, system 100 can include a single access device, such as access device 150 or access device 160, or multiple access devices. According to one embodiment, access devices 150 and 160 are used by an end user, such as a tax or sales professional, to provide a listing of data items for global export or import to the system 100. Access devices 150 and 160 are also used for presentation of one or more scored country export control numbers that are selected by the end user.

Further, it should be noted that the system 100 shown in FIG. 1 is only one embodiment of the disclosure. Other system embodiments of the disclosure may include additional structures that are not shown, such as secondary storage and additional computational devices. In addition, various other embodiments of the disclosure include fewer structures than those shown in FIG. 1. For example, in one embodiment, the disclosure is implemented on a single computing device in a non-networked standalone configuration. Data input and requests are communicated to the computing device via an input device, such as a keyboard and/or mouse. Data output, such as the computed significance score, of the system is communicated from the computing device to a display device, such as a computer monitor.

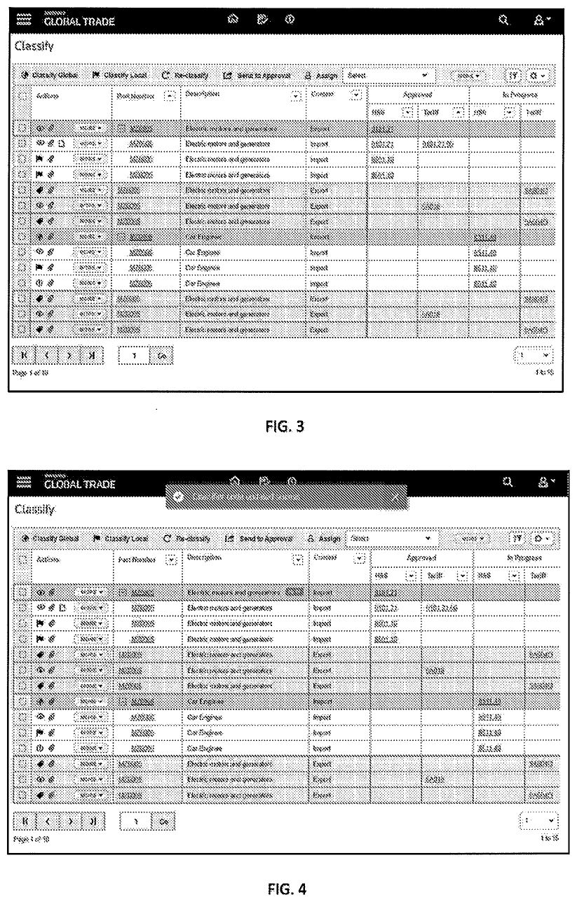

Turning now to FIG. 2, an exemplary method 200 for automatically determining export control classification is disclosed in the context of system 100 of FIG. 1. In the illustrated embodiment shown in FIG. 2, one or more product data items associated with products for global export and import are transmitted from the access device 150 or the access device 160 over the network 140 and received by the transmission module 124 and stored in the product data store 134 of the server 110, step 202. FIGS. 3 and 4 provide exemplary user interfaces whereby a product listing for electric motors and generators are uploaded via the access device 150 or 160.

At step 204 of FIG. 2, the classification module 122 of the server 110 selects a given product data item from the one or more product items associated with products for global export and import. The classification module 122 of the server 110 compares the selected product data item to a set of country export lists maintained in the ECN data store 132 using machine learning, step 206. According to one embodiment, the ECN data store maintains a repository of multiple ECN classification lists from different countries in different languages. Table 1 provides an exemplary list of ECN classification list sources and the available languages those sources are in.

TABLE 1

| Country | Language |
|---|---|
| Australia | EN |
| Canada | EN/FR |
| China | CN-S |
| EU | EN/FR/SP/PT |
| Hong Kong | EN/CN |
| India | EN |
| Japan | EN/JP |
| Malaysia | EN/BH |
| New Zealand | EN |
| Singapore | EN |
| South Korea | KR |
| Taiwan | EN |
| US | EN |

Returning to FIG. 2, according to one embodiment, the ECN classification lists are obtained from public courses, such as government websites, in the local language and in any associated English translations when available. The ECN classification lists are then standardized by the classification module 122 and stored in the ECN data store 132 to provide for the same layout for subsequent processing and display. Once standardized, the classification module 122 will use machine learning techniques to compare text in the associated product descriptions of individual ECNs maintained in the ECN classification lists with the associated keywords from the selected product data item. For Example, FIG. 5 presents an exemplary graphical user interface whereby the selected product data item for export that needs to be classified is an “Infrared Camera for underwater” as shown in the description field 502.

Returning to FIG. 2, the classification module 122 compares the terms “Infrared” “Camera” and “Underwater” to the descriptions for each ECN in each of the country specific-ECN classification list that is available in the English language. The classification module 122 may use natural language tools to reduce false matches, as well as stemming techniques. Bigram processing may also be used whereby two adjacent words are treated as a single term. In another embodiment, the classification module 122 may use an additional technique to search ECN classification lists that are not available in English. In this exemplary embodiment, countries with multiple languages available for its ECN classification lists are used as a hub to connect countries that don't have a common language. For example, Hong Kong provides its ECN classification lists in both Chinese and English. To find a match from United States to China, the classification module 122 analyzes the US ECN classification list descriptions, identifies similar product descriptions in the Hong Kong ECN classification list descriptions in English, and the associated ECN classification list description in Chinese is compared to the ECN classification list descriptions provided by China.

In yet another embodiment, the classification module 122 uses matching option based on the relationship between the ECN and the Harmonized Commodity Description and Coding Systems (HS) previously filed by other companies to the government agencies. For example, the European Union publishes a list of harmonized tariff numbers and what export control number they are equal to. This is a one to one relationship and allows for the classification module 122 to take advantage of the known tariff number. In another example, the classification module 122 may utilize US census data regarding exports available from public source.

At step 208 of FIG. 2, the classification module 122 identifies one or more country export control numbers that are a potential match to the selected product data item based on said comparison. The classification module 122 then scores each of the one or more country export control numbers, step 210. In one embodiment, a matching percentage score is determined based on how likely an ECN code is the accurate code to a certain product, based on various scenarios: (i) based on how similar the suggested ECN description is to a previously assigned ECN from another country; and (ii) based on the relation of the ECN and HS Code previously filed by other companies to the government agencies. The scoring is important to guide the user towards the most likely code to be selected, reducing classification time and mitigating risks of wrong classification, what can lead to severe penalties.

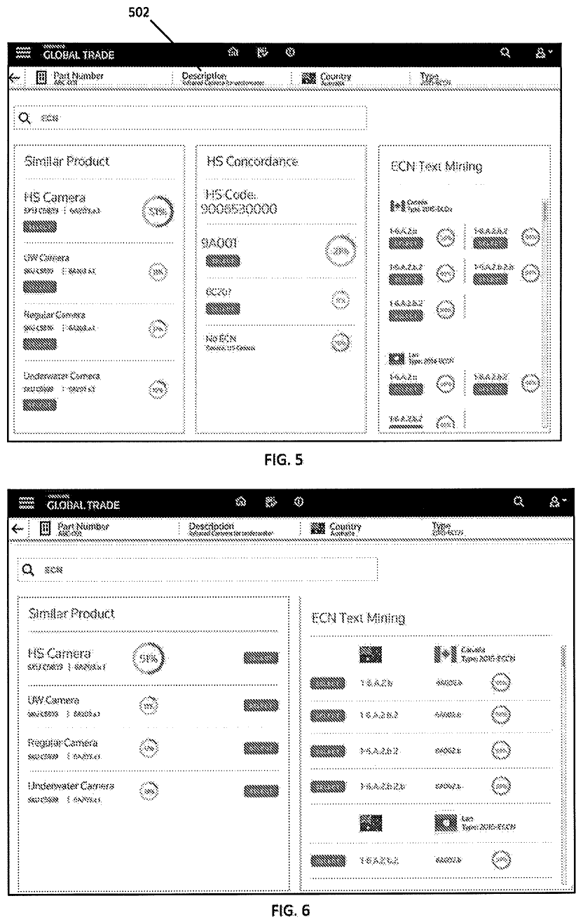

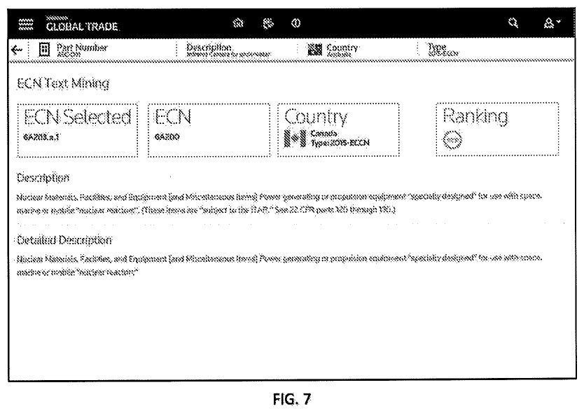

Returning to FIG. 2, the transmission module 124 presents each of the scored country export control numbers on a graphical user interface for selection at the access device 150 or 160, step 212. FIGS. 5 and 6 present exemplary graphical user interfaces whereby a series of scored country export control numbers are presented. At step 214, an end user selects a scored country export control number at the access device 150 or 160, which is received by the transmission module 124 and stored in the product data store 134 in association with the selected product data item. FIG. 7 presents exemplary graphical user interfaces that shows the selected ECN classification, which had been previously provided to the user as a 90 percent matching rate.

FIGS. 1 through 7 are conceptual illustrations allowing for an explanation of the present disclosure. It should be understood that various aspects of the embodiments of the present disclosure could be implemented in hardware, firmware, software, or combinations thereof. In such embodiments, the various components and/or steps would be implemented in hardware, firmware, and/or software to perform the functions of the present disclosure. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the disclosure as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present disclosure to a single embodiment, as other embodiments are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific embodiments so fully reveals the general nature of the disclosure that others can, by applying knowledge within the skill of the relevant art(s) (including the contents of the documents cited and incorporated by reference herein), readily modify and/or adapt for various applications such specific embodiments, without undue experimentation, without departing from the general concept of the present disclosure. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present disclosure have been described above, it should be understood that they have been presented by way of example, and not limitations. It would be apparent to one skilled in the relevant art(s) that various changes in form and detail could be made therein without departing from the spirit and scope of the disclosure. Thus, the present disclosure should not be limited by any of the above-described exemplary embodiments, but should be defined only in accordance with the following claims and their equivalents.

What is claimed is:

1. A computer-implemented method for classifying global imports and exports comprising:
receiving one or more product data items each associated with a product for global export or import;
selecting one product data item from the one or more product data item associated with products for global export and import;
comparing the selected product data item to a set of country export control lists using machine leaning;
identifying one or more country export control number that are a potential match to the selected product data item based on said comparison;
scoring each of the one or more country export control numbers;
presenting each of the scored export control numbers on a graphical user interface for selection at an access device; and
receiving the selected scored country export control number.
